(19) United States
(12) Patent Application Publication
(10) Pub. No.: US 2007/0044379 A1
(43) Pub. Date: Mar. 1, 2007

(54) Chemical hydrogen generating device

(76) Inventor: Francis Giroux, Queensbury, NY (US)

Correspondence Address: LAW OFFICE OF MAI VU PARE, 9107 WILSHIRE BLVD. #450, BEVERLY HILLS, CA, 90210, US

(21) Appl. No.: 11/331,881

(22) Filed: Jan. 17, 2006

Related U.S. Application Data
(63) Continuation-in-part of application No. 11/209,222, filed on Aug. 23, 2005.

(51) Int. Cl. H01M 8/06

(52) U.S. Cl. 48/61; 422/236; 423/657; 423/658

(57) ABSTRACT

The present invention relates to a device used to produce a gas product from a chemical reaction between a liquid reactant and a solid reactant, and is capable of being fully manual with no moving parts. The present invention operates on principles of pressure created from gas production and removal of gas produced.

This application is a continuation in part of application Ser. No. 11/209,222 filed on Aug. 23, 2005.

### FIELD OF INVENTION

This invention relates to a device that produces gas.

### BACKGROUND OF INVENTION

Hydrogen gas is a fuel source that can eventually reduce our dependence on fossil fuel sources. It is well known in the art that metals can react with a basic solution to form hydrogen gas. The present invention employs the reaction between a metal and basic solution to produce gas. Hydrogen gas is one such gas that can be produced using the present invention.

Prior art hydrogen generator devices are generally complex and expensive to manufacture. Recent developments in hydrogen production research have been focused on hydrogen production for powering automotive vehicles as an alternative to hydrocarbons. Prior art devices have been difficult to operate, do not produce sufficient amounts of gas, and/or have not been suitable for residential purposes.

U.S. Pat. No. 6,866,756, titled “Hydrogen Generator for Uses in a Vehicle Fuel System”, discloses a complex system in which water is electrolyzed into hydrogen gas and oxygen gas, for use in an automotive system.

U.S. Pat. No. 6,607,703 titled “Hydrogen Generator Hydrocarbon type Fuel Combustion” discloses a system in which the combustion of hydrocarbons is used for the vaporization of water and production of hydrogen gas.

U.S. Pat. No. 6,800,258 titled “Apparatus for Producing Hydrogen” discloses a system in which hydrogen gas is produced by reacting aluminum with water in the presence of sodium hydroxide as a catalyst. The invention relies on the use of a timer to control the production of hydrogen gas. The claims of the patent are limited to the use of specific temperatures and molar concentrations of NaOH to carry out the claimed invention.

In contrast to the above prior art devices, the present invention provides for a low-cost, user-friendly means of producing hydrogen gas. It is an object of the present invention to provide for a hydrogen generating device that is relatively inexpensive to manufacture. It is another object of the present invention to provide a hydrogen generating device that is fueled by inexpensive and abundant fuel materials. Another object of the present invention is to provide a hydrogen generating device that is easy for the layperson and non-scientist to use and can be portable. Furthermore, it is an object of the present invention to provide for a hydrogen generating device that is capable of being fully manual without any need for powered or moving parts, yet can also incorporate external energy sources to optimize production.

### SUMMARY OF INVENTION

The present invention is a fully manual, automatic pressure driven device capable of generating hydrogen gas through the reaction of a solid in the presence of a liquid.

### BRIEF DESCRIPTION OF DRAWINGS

FIG. 1 is a side planar view of the hydrogen generating device without the presence of solution or metal reactant.

FIG. 2 is a side planar view of the hydrogen generating device at equilibrium.

FIG. 3 is a side planar view of the hydrogen generating device in production mode.

FIG. 4 is an alternative embodiment of the invention where weights are used to control the pressure of gas produced.

### DETAILED DESCRIPTION OF DRAWINGS

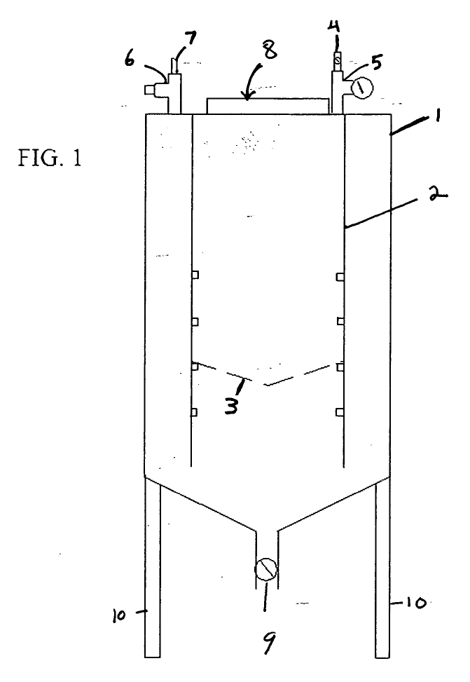

FIG. 1 shows a planar view of a preferred embodiment of the invention. An external compartment 1 holds most of the liquid reactant when no reaction is taking place. An internal compartment 2 holds a solid reactant on a screen 3. A removable cap 8 allows for the addition of solid reactants and adjustment of the height of the screen. An outlet valve 4, and a pressure gauge 5 can be attached to the top of the internal compartment 2. A pressure relief valve 6 protects the device from extreme pressure and an air valve 7 is used to adjust the desired gas production pressure. A drain valve 9 is used to drain out solid waste products of the chemical reaction within. Support legs 10 may be attached to the bottom of the device to keep it in a vertical position.

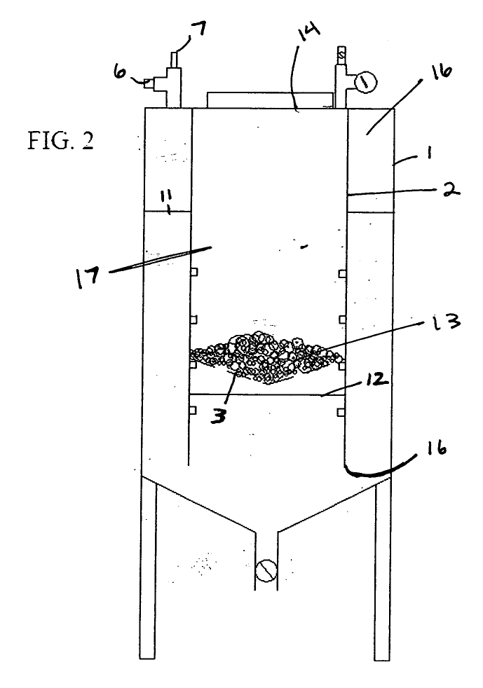

FIG. 2 is a side planar view of the hydrogen generating device at equilibrium. A solution is placed within the compartments 1,2. In FIG. 2, the solution level within the external compartment 11 is higher than the solution level within the internal compartment 12. The differing solution levels between the two compartments will be discussed in more detail below.

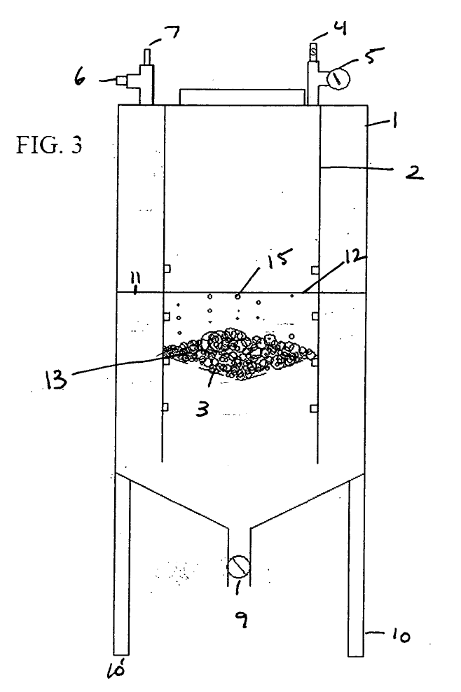

FIG. 3 is a side planar view of the hydrogen generating device in production mode. When hydrogen gas 15 is extracted from the internal compartment, the pressure above the solution within the internal compartment 12 is reduced. The surface of the solution in the external compartment moves downwards as a result of the reduced pressure within the internal compartment. This movement can result in the solution levels in the internal compartment 12 and external compartment 11 being equal. It is also possible for the solution level in the external compartment to become lower than the solution level in the internal compartment if the gas pressure in the internal compartment is further reduced.

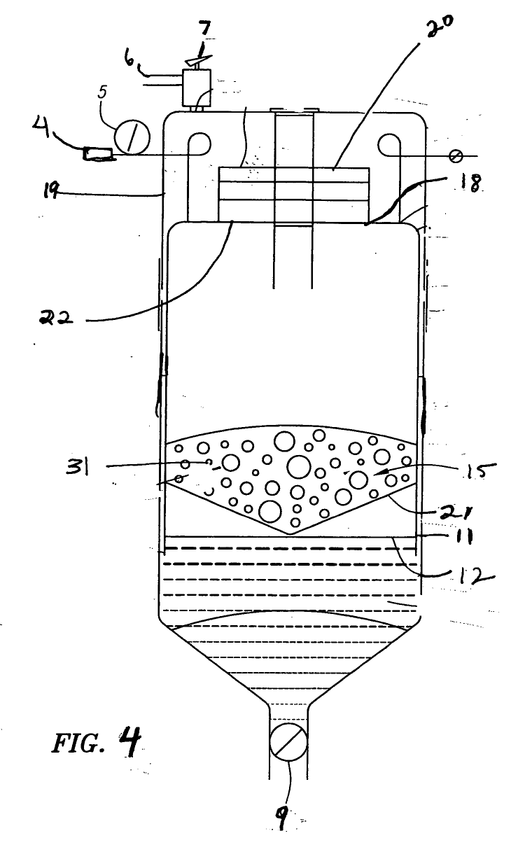

FIG. 4 shows an alternative embodiment of the present invention where weights 20 are used to control the amount of gas production. Weights 20 are attached to the internal compartment. The level of weight can be adjusted according to the amount of gas the user wishes to produce.

### MODE OF OPERATION OF A PREFERRED EMBODIMENT

A preferred embodiment of the present invention will be described below. It should be appreciated that variations to the following description may be made to the device, and still fall within the spirit of the invention and the scope of protection granted by this patent.

In a preferred embodiment of the invention, aluminum is reacted with a NaOH solution. It should be noted however that various metals can be used to produce hydrogen gas in the present invention, including magnesium, manganese, and zinc. In addition, potasium, barium, strontium, and calcium may be used with the present invention and reacted with water, to also produce hydrogen gas. Because aluminum and NaOH are readily available to laypersons, they are ideal compounds to fuel the production of hydrogen gas in the present invention. It should be further noted that the invention is not limited to the production of hydrogen gas but can be used to produce any gas that is the product of reaction between a liquid reactant and a solid reactant.

FIG. 2 shows the present invention at equilibrium, with no hydrogen gas being produced. No external power source is required to operate the invention. The present invention is driven by pressure differences between the internal compartment and external compartment. The area above the solution within the external compartment 16 can be adjusted by the removal of air from the pressure relief valve 6 or addition of air through the air valve 7. The pressure within the area above the solution within the internal compartment 17 is increased when hydrogen gas is produced and decreased when hydrogen gas is removed.

In FIG. 2, the solution level within the external compartment 11 is higher than the solution level within the internal compartment 12. Hydrogen gas is not being produced in FIG. 2. The top most end of the internal compartment 14 is airtight when hydrogen gas is not being removed from the device. The bottom most end of the internal compartment 16 however, open and is closed off by solution. The external compartment has the capability of being airtight. At equilibrium, the pressure above solution within the internal compartment equals the pressure above solution within the external compartment.

As seen in FIGS. 2 and 3, reaction between aluminum and a NaOH solution occurs in the internal compartment on the screen 3. When the aluminum 13 is in contact with the NaOH solution, hydrogen gas is produced. When the internal compartment is in its airtight state, pressure above the solution within the internal compartment 16 increases. As the hydrogen pressure within the internal compartment increases and exceeds the pressure above the solution within the external compartment 17, the solution within the internal compartment is gradually pushed downwards. As hydrogen is continually produced, the pressure above the solution within the internal compartment continues to exceed the pressure above solution within the external compartment, pushing the solution within the internal compartment further away from the screen. Once the screen is isolated from solution and the aluminum has reacted with all remaining solution in contact with it, the reaction ceases.

Removal of hydrogen gas from the internal compartment triggers the reverse process. Removal of hydrogen gas from the internal compartment reduces the pressure above the solution within the internal compartment. When the pressure above the solution within the internal compartment is lower than the pressure above solution within the external compartment, solution within the external compartment moves downwards, while the solution within the internal compartment moves upwards. As more hydrogen is drawn from the internal compartment, the solution level within the internal compartment continues to rise until it is again in contact with the metal reactant, to produce more hydrogen gas.

The amount of hydrogen produced by the present invention is regulated according to 1) the weight of aluminum metal that is able to react with the solution, 2) the molar concentration of the NaOH solution, and 3) the pressure above the solution within the external compartment. The first and second factors are based on the fact that hydrogen gas cannot continue to be produced once all of the aluminum and NaOH has reacted. The pressure above the solution within the external compartment affects the amount of hydrogen produced because it determines the duration in which the aluminum is kept in contact with solution.

The external compartment contains means for adjusting the pressure within it, either through the removal of pressure 6, or the addition of air 7. If high pressure is maintained in the external compartment, more hydrogen must be produced in the internal compartment in order exert enough force to push down upon the solution within the internal compartment, so that solution is directed away from the screen to stop the reaction. If the user desires less hydrogen, the pressure within the external compartment should be lowered so that less pressure is needed to push the solution within the internal compartment away from the screen to stop the reaction.

FIG. 4 shows an alternative embodiment of the present invention whereby hydrogen production is controlled through the use of weights 20. An additional difference between the two embodiments is that the internal compartment 18 floats within an external compartment 19 and is loosely connected to the external compartment. This results in movement of the internal container itself within the external compartment, on pressure changes within the internal compartment.

Similar to the embodiment described above, metal reactant 31 is placed on a screen 21 within the internal compartment. Hydrogen gas is produced when the metal reactant 31 is in contact with the solution as a result of the solution being in contact with a screen 21. As more hydrogen gas is produced, pressure increases within the internal compartment. This results in both the solution being pushed downwards, while the internal compartment is moved upwards. Adjusting the level of weights on the internal compartment determines the amount of hydrogen pressure required to accomplish movement of the solution within the internal compartment as well as movement of the internal compartment itself.

Continuing with FIG. 4, the weight storage means 22 allows for weights to be attached or stored on the internal compartment. The weights 20 placed within the weight compartment can be increased or decreased depending on the pressure of hydrogen gas desired by the user. If more hydrogen gas is desired, more weight is added to the weight compartment. Thus, when hydrogen gas is produced with additional weight added to the weight compartment, more hydrogen gas must be produced in order to push down on the NaOH solution and move the internal container upwards, away from the NaOH solution. Thus more hydrogen gas must be produced to stop the reaction. If less gas is needed, weight is removed from weight compartment, resulting in the NaOH solution being pushed down away from the screen more easily when the device is in production mode, so that the reaction is more easily stopped.

In all embodiments, the metal must be replenished when it has completely reacted with solution. All embodiments provide for a means to access the screen within the internal compartment so that more metal can be replenished. In a preferred embodiment of the invention, the screen which holds the metal reactant has a conical shape 3,21 as shown in FIGS. 1-4. The screen can be removed and adjusted to different positions within the internal compartment. Said screen is used to hold aluminum pieces and other scrap metal 13 that will be used to fuel hydrogen production. As discussed above, the reaction between the aluminum and the solution is slowed down as the screen is separated from the solution. The reaction is completed when the remaining solution covering the aluminum pieces has reacted. The conical shape of the screen improves the draining of the aluminum pieces from the solution when hydrogen is no longer needed, increasing the speed in which the reaction is terminated.

A further detail of the internal compartment is shown in FIGS. 1-4; the bottom most portion of the screen is not flush with the end of the internal compartment. This is because the bottom most portion of the internal compartment is in contact with solution at all times. If the screen were to be placed flush with the bottom of the internal compartment, reaction would continually take place, and there would be no means of stopping the reaction without relying on an external power source to completely separate the internal compartment from the NaOH solution. It is to be emphasized that the present invention is capable of operating fully manually, with no dependence on any external energy source, since there are no externally powered moving parts.

The compartments may contain additional openings that allow various functions to take place within the device. Either compartment may include an opening for a pressure gauge to be fitted for reading the pressure within the device. An opening may be provided to allow for the maintenance of the water level within the compartments. Alternatively, an opening may be provided to include a float switch that is electrically powered to automatically regulate the water level. An opening may be provided to allow for pressure relief in the event of over production on of gas. The bottom of the external compartment may provide for a drain in which solid waste products may be removed.

It should be noted that the two compartments could also be separate containers and the means of communication between them could be external plumbing connecting the separate containers. Thus the present invention is not limited to the configuration described above but is merely a preferred embodiment. Both the internal and external compartments should be constructed from at least 316 stainless steel grade or higher, or any other material that will not react with the NaOH or other basic solution.

In summary, the above hydrogen generating device is a low cost, potentially portable, hydrogen generating device that has many applications for use on both a commercial and residential level. With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention.

1. A device for producing a gas product from a chemical reaction between a liquid reactant and a solid reactant, comprising:
A first compartment for holding a liquid reactant, having a means to contain a gas pressure;
A second compartment for holding a solid reactant, having a means to contain a gas pressure;
A means of communication between the first compartment and the second compartment so that the liquid reactant meets the solid reactant in the second compartment when the gas pressure in the second compartment is reduced and the liquid reactant is separated from the solid reactant when the gas pressure in the second compartment is increased; and
A means for removing the gas product from the device.

2. The device as claimed in claim 1 where one compartment is contained within another compartment.

3. The device as claimed in claim 1 where the compartments are two or more separate containers connected by plumbing.

4. The device as claimed in claim 1 wherein said compartments contain openings to provide for a means of measuring pressure within said compartments.

5. The device as claimed in claim 1 wherein said compartment contains a means of adding liquid to said compartments.

6. The device as claimed in claim 1 containing a means to relieve excess pressure within the compartments.

7. The device as claimed in claim 1 containing a means of increasing and decreasing the pressure within the containers.

8. The device as claimed in claim 1 wherein a means is provided to remove solid waste product.

9. The device as claimed in claim 1 wherein said first compartment and said second compartment are constructed from 316 stainless steel grade.

10. A device for producing a gas product from a chemical reaction between a liquid reactant and a solid reactant, comprising:
A first compartment for holding a liquid reactant, having a means to contain a gas pressure;
A second compartment contained within said first compartment, having a means to contain a gas pressure and hold the solid reactant;
A means of communication between the first compartment and the second compartment so that the liquid reactant contained within said first compartment meets the solid reactant in the second compartment when the gas pressure in the second compartment is reduced and the liquid reactant is separated from the solid reactant when the gas pressure in the second compartment is increased; and
A means for removing the gas product from the device.

11. The device as claimed in claim 10 where the compartments are two or more separate containers connected by plumbing.

12. The device as claimed in claim 10 wherein said compartments contain openings to provide for a means of measuring pressure within said compartments.

13. The device as claimed in claim 10 wherein said compartment contains a means of adding liquid to said compartments.

14. The device as claimed in claim 10 containing a means to relieve excess pressure within the compartments.

15. The device as claimed in claim 10 containing a means of increasing and decreasing the pressure within the containers.

16. The device as claimed in claim 10 wherein a means is provided to remove solid waste product.

17. The device as claimed in claim 10 wherein said first compartment and said second compartment are constructed from 316 stainless steel grade.
